(19) United States
(12) Patent Application Publication
(10) Pub. No.: US 2012/0146756 A1
(43) Pub. Date: Jun. 14, 2012

(54) Current Compensated Inductor and Method for Producing a Current Compensated Inductor

(75) Inventors: Bernhard Roellgen, Muenchen (DE); Karl Stoll, Germering (DE)

(73) Assignee: EPCOS AG, Muenchen (DE)

(21) Appl. No.: 13/388,266

(22) PCT Filed: Jul. 27, 2010
(86) PCT No.: PCT/EP2010/060897

§ 371 Date: Feb. 29, 2012

(30) Foreign Application Priority Data
Aug. 6, 2009 (DE) 10 2009 036 396.3

(51) Int. Cl. H01F 27/30

(52) U.S. Cl. 336/196

(57) ABSTRACT

The invention relates to a current compensated inductor comprising a single piece annularly closed ferrite core. The ferrite core comprises at least two wire coils each comprising a flat wire wound on edge and disposed, for example, without a coil bobbin and at a distance from each other on the ferrite core.

This patent application is a national phase filing under section 371 of PCT/EP2010/060897, filed Jul. 27, 2010, which claims the priority of German patent application 10 2009 036 396.3, filed Aug. 6, 2009, each of which is incorporated herein by reference in its entirety.

### BACKGROUND

German publication DE 102004008961 B4 discloses a current compensated inductor.

### SUMMARY

In one aspect a current compensated inductor that has a high current carrying capacity is specified.

A current compensated inductor is specified that has a single-piece ferrite core which is in the form of a closed ring. The ferrite core has at least two wire coils each comprising a flat wire wound upright. The wire coils are without a coil former and are arranged spaced apart from one another on the ferrite core.

A single-piece ferrite core which is closed in the form of a ring is understood to be a “single-layer” ferrite core with a homogenous design and without an air gap. Closed in the form of a ring means here that any desired surface is enclosed.

A current compensated inductor with a single-piece ferrite core has a comparatively high inductance compared to a current compensated inductor with a multi-part ferrite core with an air gap given approximately the same number of turns of the winding.

Compared to a current compensated inductor with a ferrite core which is composed of a single piece, a current compensated inductor having a ferrite core composed of bonded ferrite core halves has only approximately 20 to 50% of the inductance.

The wire coils of the current compensated inductor each have a flat wire which is shaped upright to form a winding. Compared with a round wire, whose diameter corresponds to the width of the flat wire, the flat wire has a larger cross section than the round wire. Given the same cross section of the flat wire and round wire, more turns can be applied per winding layer with the flat wire than with a round wire. Compared to windings made of round wire, windings made of flat wire with a comparable number of turns have a lower direct voltage resistance owing to the high filling level, as a result of which the current compensated inductor heats up less strongly given the same current loading. The individual turns of the wire coil are built up here in such a way that the long sides of the flat wire point toward one another. As a result of such a design of the wire coil which is wound upright, the latter has a large effective surface with only a small number of turns.

As a result of the large effective area of the flat wire coil, eddy currents build up in the wire coils at high frequencies. The eddy currents bring about a desired increase in the series resistance of the wire coils (proximity effect) at high frequencies.

The skin effect is also significantly more pronounced in flat wire coils and, for example, in wire coils made of stranded wires, which also leads to high frequency losses in a way which is desired for the inductor.

In one embodiment, the wire coils are arranged on the ferrite core in such a way that they are at a distance from one another which is as large as possible.

They are preferably arranged on sections of the ferrite core that are parallel to one another.

In one embodiment, the ferrite core therefore has a rectangular shape. In one embodiment, the wire coils are arranged on the shorter limbs of the ferrite core. If the windings are each arranged on the shorter limbs, this results in a spatially larger distance between the wire coils than when there is an arrangement on the longer limbs of the rectangular ferrite core.

In a further embodiment, the ferrite core has a toroidal shape. The ferrite core is preferably embodied as a ring torus, wherein the opening of the torus has a base surface which corresponds either to a circle or to an ellipse. In the case of a ring torus with an ellipsoidal base surface of the opening, the wire coils are preferably arranged in the sections of the torus which are at a distance from one another which is spatially as large as possible.

In one embodiment of the current compensated inductor having a rectangular or toroidal ferrite core, a spatially large distance can therefore be brought about between the two wire coils. This has the effect that, despite a single-part ferrite core, approximately 2% of the main inductance occurs as leakage inductance. The leakage inductance acts effectively as an additional inductor coil and damps push-pull interference. Ferrite cores with a rectangular shape are particularly effective in this context.

In one embodiment, the wire coils each have just one layer. However, it is also possible to provide a plurality of layers one on top of the other and preferably to connect them electrically in parallel.

An ideal current compensated inductor preferably has a high resonant frequency of the wire coils. In order to increase the resonant frequency it is advantageous if the parasitic capacitances are reduced. As a result of the single-layer design of the wire coils of the previously described current compensated inductor, the wire coils have the practically smallest possible parasitic capacitance, because this is a series connection of parasitic capacitances which are each formed by one turn with the adjacent turn.

In order to reduce the parasitic capacitance of a conventional multi-layer wire coil, it is advantageous if the wire coil is divided into individual chambers. In conventional current compensated inductors, the division into chambers is achieved by corresponding dividing walls between the windings on the coil former. However, this reduces the space available for the windings themselves. This problem becomes greater as the number of chambers increases.

The current compensated inductor described above with flat wire coils preferably has a design of the coil wires which is without a coil former. Each turn of the wire coil corresponds here to a chamber. The wire coils are therefore not restricted to a number of physical chambers which is predefined by a coil former.

As a result of the design of the current compensated inductor with a single-piece ferrite core and the use of single-layer flat wire coils, the DC resistance and the parasitic capacitance of the inductor are reduced. On the other hand, the desired high frequency losses can be maximized by this design of the inductor.

In one embodiment, the wire coils are arranged in such a way that, given a symmetrical electrical connection, they have opposing winding directions to one another. The wire coils preferably have the same number of turns.

In one embodiment, the ferrite core has an electrically insulating coating.

The coating comprises, for example, epoxide or parylene. Given a thickness of the coating of less than or equal to 0.4 mm, such a coating has a breakdown voltage of more than 2000 V_{RMS} (RMS=root mean square). The coating complies with the fire protection class UL94V-0.

In one embodiment, the current compensated inductor is arranged with a preferably uncoated ferrite core in a plastic housing. The winding is then arranged on this housing. The housing preferably provides the same electrical insulation as an insulating coating of the ferrite core. In one embodiment, the housing has devices for securing the wire ends of the current compensated inductor.

Furthermore, a circuit arrangement with a current compensated inductor as described above is specified, wherein the current compensated inductor is connected in series with a bridge rectifier. The current compensated inductor is installed in the main circuit of an application circuit, for example, downstream of the bridge rectifier on the rectified side. However, it can also be installed upstream of the bridge rectifier.

The current compensated inductor is preferably connected in such a way that the magnetic flux which is generated in the first winding is opposed to the magnetic flux which is generated in the second winding, and the two fluxes therefore compensate one another.

As a result of the installation downstream of a bridge rectifier, the current flow through the two coil windings of the current compensated inductor occurs only in one direction. As a result, magnetic fields occur in the same direction in the region of the coil winding in the ferrite core.

Furthermore, a method for producing a current compensated inductor is specified, wherein a flat wire is formed in a helical shape to form a wire coil. The pre-formed, helical wire coil is applied to a prepared ferrite core which is in the form of a closed ring, in such a way that the individual turns of the wire coil are successively wound onto the ferrite core through relative rotation between the wire coil and the ferrite core.

In order to facilitate the winding process, all the edges of the ferrite core can preferably be chamfered, that is to say the edges are beveled or rounded.

The wire coil is preferably applied in a single layer to the ferrite core. It is also possible to apply two windings one on top of the other and to connect them electrically in parallel. Given a suitable diameter, the two windings can also be wound one on top of the other with the method.

In a further embodiment, a second pre-formed wire coil is applied to the ferrite core in accordance with the method described above, wherein the second wire coil is preferably applied to the ferrite core with an opposing winding direction.

The second wire coil is preferably applied to the ferrite core in such a way that the spatial distance between the two coil windings is as large as possible.

As a result of the method described above, preferably flat wire coils which are in a slightly extended state can be, as it were, screwed, through rotation, onto the single-piece, rectangular or toroidal ferrite core. The method described above is particularly suitable for flat wire coils which are wound upright.

As a result of the design of the current compensated inductor with a single-layer flat wire coil, no additional coil former is required. For example, a small number of droplets of a, for example, UV curing adhesive, are sufficient to secure the connections of the wire coils. For applications in which carrier boards are advantageous, the carrier boards can also be combined with the current compensated inductor described above.

As a result of the design of the current compensated inductor with low-impedance wire coils which are made of flat wire and are arranged on a single-part ferrite core, the intrinsic heating of the current compensated inductor is limited. The rated current is dependent on the thermally possible maximum current which is conditioned by the saturation of the ferrite core.

In one exemplary embodiment, a previously described current compensated inductor has, for example, a base area of approximately 27×26 mm and a height of 11 mm, wherein the inductor has a rectangular ferrite core with two wire coils, each with an inductance of 1 mH. In this embodiment, the current compensated inductor can be modulated, for example, up to approximately 5 A (peak current). The leakage inductance of the current compensated inductor is approximately 37% higher here compared to an inductor based on an annular core.

### BRIEF DESCRIPTION OF THE DRAWINGS

The embodiments and methods described above will be explained in more detail below with reference to the following figures and exemplary embodiments.

The drawings described below are not to be considered true to scale.

In the drawings:

FIG. 1 shows a first embodiment of the current compensated inductor with a ferrite core;

FIG. 2 shows the profile of the saturation of a ferrite core of a current compensated inductor as a function of the rated current;

FIG. 3 shows the distribution of the flux density of an embodiment of a current compensated inductor;

FIG. 4 shows a circuit diagram of an application circuit with a current compensated inductor;

FIG. 5 shows the winding of a closed ferrite core with a pre-formed coil winding; and

FIG. 6 shows a further embodiment of the current compensated inductor with a ferrite core in a toroidal shape.

### DETAILED DESCRIPTION OF ILLUSTRATIVE EMBODIMENTS

FIG. 1 shows a first embodiment of the current compensated inductor 1 with a rectangular ferrite core 2. The ferrite core 2 has two wire coils 4, 5 which are arranged on opposite sides of the ferrite core 2.

In a further embodiment (illustrated later), the ferrite core is in the form of a ring torus.

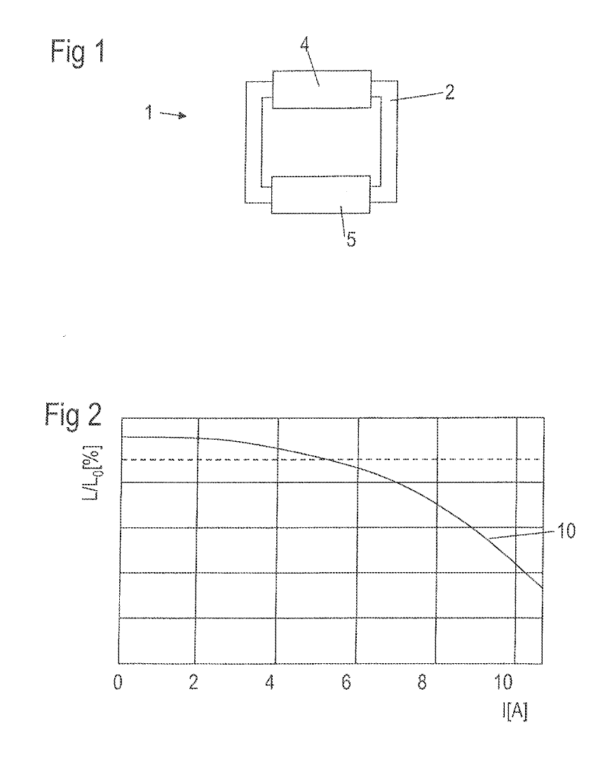

FIG. 2 shows the profile 10 of the relative inductance L/L₀ as a function of the current strength I. The current strength I is plotted in amperes on the X axis of the diagram. The relative inductance is specified as a percentage on the Y axis. The relative inductance L/L₀ gives the inductance for a predefined current in comparison with the inductance value L₀ without current loading. The decrease is caused by the current in the current compensated operating mode when the core material is magnetized as a function of the field strength. A current compensated inductor according to an embodiment of the invention has, given a current strength of approximately 5.5 A, a relative inductance of approximately 90%. At 9 A, the current compensated inductor still has a relative inductance of 60%.

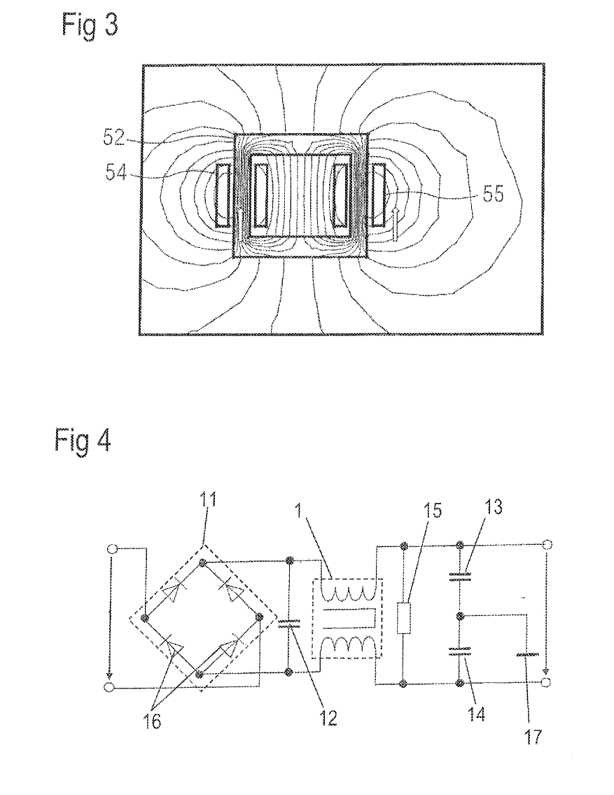

FIG. 3 shows the distribution of the flux density in the ferrite core 52 of a current compensated inductor when energized with rated current. A maximum of the magnetization occurs in the region of the wire coils 54 and 55.

FIG. 4 is a schematic view of a current compensated inductor in a circuit diagram of an application circuit. The application circuit shows a described current compensated inductor 1 which is connected in series with a bridge rectifier 11. The design of the current corresponds approximately to a line filter.

When the current compensated inductor 1 is installed downstream of the bridge rectifier 11, a flow of current through the two windings of the current compensated inductor 1 occurs only in one direction. As a result, the ferrite core of the current compensated inductor 1 is always magnetized in the same direction.

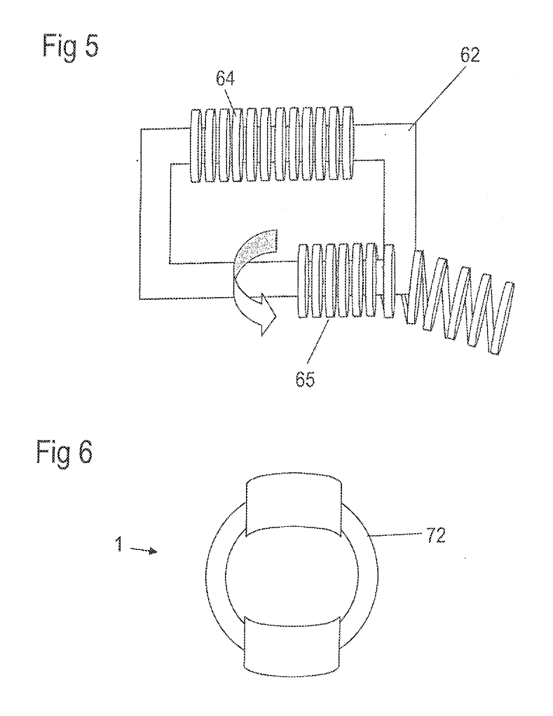

FIG. 5 shows the winding of a closed, rectangular ferrite core 62 with a wire coil 65. In the illustrated step, a first wire coil 64 is already applied to the ferrite core 62. In the figure, the second wire coil 65 is wound over approximately half of the ferrite core 62. In this context, the pre-formed wire coil 65 is applied to the ferrite core 62 in the extended state through rotation. The individual turns of the wire coil 65 are “screwed” onto the ferrite core 62 through a relative rotation between the wire coil 65 and the ferrite core 62. The ferrite core 62 has a closed shape.

FIG. 6 shows a further embodiment of the current compensated inductor 1 which is similar to the embodiment of the current compensated inductor shown in FIG. 1, wherein the ferrite core 72 of the inductor 1 in FIG. 6 has a toroidal shape.

### LIST OF REFERENCE NUMERALS

1 Current compensated inductor
2, 52, 62, 72 Ferrite core
4, 54, 64 Wire coil
5, 55, 65 Wire coil
10 Saturation profile of an inductor
11 Bridge rectifier
12, 13, 14 Capacitor
15 Resistor
16 Diode
17 Ground

1-12. (canceled)

13. A current compensated inductor, comprising:
a single-piece ferrite core in the form of a closed ring having a rectangular shape and an electrically insulating coating, wherein the ferrite core has at least two wire coils with a high filling level, each wire coil composed of a flat wire wound upright, the wire coils being-arranged spaced apart from one another without a coil former on the ferrite core.

14. The current compensated inductor according to claim 13, wherein the wire coils each have just one layer.

15. The current compensated inductor according to claim 13, wherein a spatial distance which is as large as possible is maintained between the two wire coils.

16. The current compensated inductor according to claim 13, wherein the wire coils are connected symmetrically with respect to one another but have opposing winding directions to one another.

17. The current compensated inductor according to claim 13, wherein the ferrite core is arranged in a housing and wherein the winding is arranged on the housing.
